(19) United States
(12) Patent Application Publication
(10) Pub. No.: US 2019/0368594 A1
(43) Pub. Date: Dec. 5, 2019

(54) Robot, Gear Device, And Method For Producing Gear Device

(71) Applicant: Seiko Epson Corporation, Tokyo (JP)

(72) Inventor: Masaaki SAKATA, Matsumoto (JP)

(21) Appl. No.: 16/430,767

(22) Filed: Jun. 4, 2019

(30) Foreign Application Priority Data
Jun. 5, 2018 (JP) 2018-107497

(51) Int. Cl. F16H 49/00; F16H 55/06; B25J 9/10

(52) U.S. Cl. CPC F16H 49/001; F16H 2049/003; B25J 9/102; F16H 55/06

(57) ABSTRACT

A robot includes a first member, a second member, a gear device transmitting a driving force for relatively pivoting the second member, and a driving source outputting the driving force to the gear device, wherein the gear device includes an internal gear, an external gear having flexibility and partially meshing with the internal gear, and a wave generator that is in contact with an inner circumferential face of the external gear and moves a meshing position of the internal gear and the external gear along a circumferential axis, and the external gear contains nickel chromium molybdenum steel as a main material, and the internal gear contains spheroidal graphite cast iron having been subjected to quenching and tempering treatment or spheroidal graphite cast iron having been subjected to austempering treatment as a main material.

The present application is based on, and claims priority from, JP Application Serial Number 2018-107497, filed Jun. 5, 2018, the disclosure of which is hereby incorporated by reference herein in its entirety.

### BACKGROUND

### 1. Technical Field

The present disclosure relates to a robot, a gear device, and a method for producing a gear device.

### 2. Related Art

In a robot including a robot arm configured to include at least one arm, for example, a joint of the robot arm is pivoted by driving a motor, however, at that time, the speed of rotation of the driving force from the motor is reduced by a speed reduction gear (gear device) and then, the rotation is transmitted to the robot arm.

As such a speed reduction gear, for example, a wave gear device as described in JP-A-2002-349681 (Patent Document 1) is known. The wave gear device described in Patent Document 1 is constituted by a rigid internal gear having an annular shape, a flexible external gear having a cup shape disposed inside the internal gear, and a wave generator having an elliptic profile and fitted inside the external gear.

However, in the wave gear device described in Patent Document 1, a constituent material of the internal gear is a high-strength aluminum alloy or a copper alloy, and a constituent material of the external gear is structural steel or stainless steel. Therefore, the device has a problem that the mechanical properties of the internal gear and the external gear are not sufficient, and the life of the gear device is short. Further, the life of the gear device is, for example, one of the factors to lower the work efficiency of a robot.

### SUMMARY

A robot according to an application example of the present disclosure includes a first member, a second member pivoting with respect to the first member, a gear device transmitting a driving force for relatively pivoting the second member, and a driving source outputting the driving force to the gear device, wherein the gear device includes an internal gear, an external gear that has flexibility and that partially meshes with the internal gear, and a wave generator that is in contact with an inner circumferential face of the external gear and that moves a meshing position of the internal gear and the external gear along a circumferential axis, one of the internal gear, the external gear, and the wave generator is coupled to the first member, and one of the rest is coupled to the second member, and the external gear contains nickel chromium molybdenum steel as a main material, and the internal gear contains spheroidal graphite cast iron having been subjected to quenching and tempering treatment or spheroidal graphite cast iron having been subjected to austempering treatment as a main material.

### BRIEF DESCRIPTION OF THE DRAWINGS

FIG. 1 is a side view showing a schematic configuration of a robot according to an embodiment of the present disclosure.

FIG. 2 is a longitudinal cross-sectional view showing a gear device according to a first embodiment of the present disclosure.

FIG. 3 is a front view (a view when seen from an axial line a direction) of a body of the gear device shown in FIG. 2.

FIG. 4 is a cross-sectional view showing a surface state of external teeth of a flexible gear included in the gear device shown in FIG. 2.

FIG. 5 is a longitudinal cross-sectional view showing a gear device according to a second embodiment of the present disclosure.

FIG. 6 is a process chart showing an embodiment of a method for producing a gear device according to the present disclosure.

FIG. 7 is an observation image using a scanning electron microscope of a polished face of a rigid gear of Example 4.

FIG. 8 is an observation image using a scanning electron microscope of a polished face of a rigid gear of Example 26.

FIG. 9 is an observation image using a scanning electron microscope of a polished face of a rigid gear of Comparative Example 1.

### DESCRIPTION OF EXEMPLARY EMBODIMENTS

Hereinafter, a robot, a gear device, and a method for producing a gear device according to the present disclosure will be described in detail based on preferred embodiments shown in the accompanying drawings.

### 1. Robot

First, an embodiment of the robot according to the present disclosure will be briefly described.

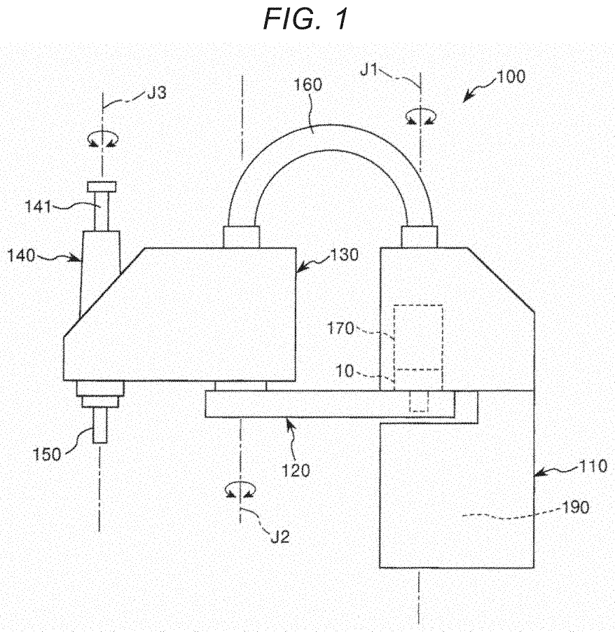

FIG. 1 is a side view showing a schematic configuration of a robot according to the embodiment of the present disclosure. In the following description, for the sake of convenience of explanation, the upper side and the lower side in FIG. 1 are referred to as “upper” and “lower”, respectively. Further, a base stand side and an opposite side thereto (an end effector side) in FIG. 1 are referred to as “base end side” and “tip side”, respectively. Further, an up and down axis and a right and left axis in FIG. 1 are referred to as “vertical axis” and “horizontal axis”, respectively.

A robot 100 shown in FIG. 1 is, for example, a robot to be used for an operation such as material feed, material removal, transport, and assembling for a precision machine or a component (a target object) constituting the precision machine. This robot 100 includes a base stand 110, a first arm 120, a second arm 130, a working head 140, an end effector 150, and a wire routing portion 160 as shown in FIG. 1. Hereinafter, the respective portions of the robot 100 will be sequentially briefly described.

The base stand 110 is, for example, fixed to a floor surface (not shown) with a bolt or the like. A control device 190 integrally controlling the robot 100 is installed inside the base stand 110. Further, to the base stand 110, the first arm 120 is coupled pivotally around a first shaft J1 (pivot shaft) along the vertical axis with respect to the base stand 110. That is, the first arm 120 relatively pivots with respect to the base stand 110.

In the base stand 110, a motor 170 (driving source) that is a first motor such as a servomotor generating a driving force for pivoting the first arm 120, and a gear device 10 that is a first speed reduction gear reducing the speed of rotation of the driving force of the motor 170 are installed. An input shaft of the gear device 10 is coupled to a rotating shaft of the motor 170, and an output shaft of the gear device 10 is coupled to the first arm 120. Therefore, when the motor 170 drives and the driving force thereof is transmitted to the first arm 120 through the gear device 10, the first arm 120 relatively pivots in a horizontal plane around the first shaft J1 with respect to the base stand 110. That is, the motor 170 is a driving source outputting a driving force to the gear device 10.

To a tip portion of the first arm 120, the second arm 130 is coupled pivotally around a second shaft J2 (pivot shaft) along the vertical axis with respect to the first arm 120. In the second arm 130, although not shown in the drawing, a second motor generating a driving force for pivoting the second arm 130 and a second speed reduction gear reducing the speed of rotation of the driving force of the second motor are installed. By transmitting the driving force of the second motor to the second arm 130 through the second speed reduction gear, the second arm 130 pivots in a horizontal plane around the second shaft J2 with respect to the first arm 120.

In a tip portion of the second arm 130, the working head 140 is disposed. The working head 140 includes a spline shaft 141 inserted into a spline nut (not shown) and a ball screw nut (not shown) coaxially disposed in the tip portion of the second arm 130. The spline shaft 141 can pivot around a third shaft J3 shown in FIG. 1 with respect to the second arm 130 and also can move along the vertical axis (go up and down).

In the second arm 130, although not shown in the drawing, a rotary motor and a lifting motor are disposed. A driving force of the rotary motor is transmitted to the spline nut by a driving force transmitting mechanism (not shown), and when the spline nut rotates forward and backward, the spline shaft 141 rotates forward and backward around the third shaft J3 along the vertical axis.

On the other hand, a driving force of the lifting motor is transmitted to the ball screw nut by a driving force transmitting mechanism (not shown), and when the ball screw nut rotates forward and backward, the spline shaft 141 vertically moves.

To a tip portion (lower end portion) of the spline shaft 141, the end effector 150 is coupled. The end effector 150 is not particularly limited, and examples thereof include an end effector holding a material to be transported and an end effector processing a material to be processed.

A plurality of wirings to be coupled to the respective electronic components (for example, the second motor, the rotary motor, the lifting motor, etc.) disposed in the second arm 130 are routed to the inside of the base stand 110 through the inside of the wire routing portion 160 in a tubular shape coupling the second arm 130 to the base stand 110. Further, such a plurality of wirings are routed to the control device 190 installed in the base stand 110 along with wirings coupled to the motor 170 and an encoder (not shown) by being gathered together in the base stand 110.

As described above, the robot 100 includes the base stand 110 that is the first member, the first arm 120 that is the second member provided pivotally with respect to the base stand 110, the gear device 10 transmitting a driving force from one of the base stand 110 and the first arm 120 to the other, and the motor 170 that is a driving source outputting a driving force to the gear device 10.

The first arm 120 and the second arm 130 may be collectively regarded as the “second member”. Moreover, the “second member” may further include the working head 140 and the end effector 150 in addition to the first arm 120 and the second arm 130.

In this embodiment, the first speed reduction gear is constituted by the gear device 10, however, the second speed reduction gear may be constituted by the gear device 10, and further, both the first speed reduction gear and the second speed reduction gear may be constituted by the gear device 10. When the second speed reduction gear is constituted by the gear device 10, the first arm 120 may be regarded as the “first member”, and the second arm 130 may be regarded as the “second member”. Further, in place of the gear device 10, a gear device 10B described below may be used.

Further, in this embodiment, the motor 170 and the gear device 10 are provided in the base stand 110, however, the motor 170 and the gear device 10 may be provided in the first arm 120. In this case, the output shaft of the gear device 10 only needs to be coupled to the base stand 110.

### 2. Gear Device

Hereinafter, an embodiment of the gear device according to the present disclosure will be described.

### First Embodiment

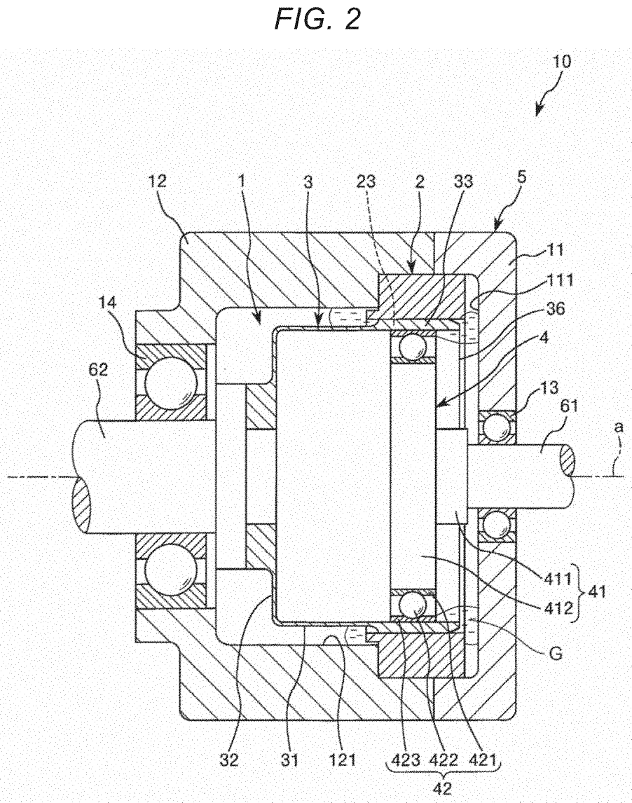

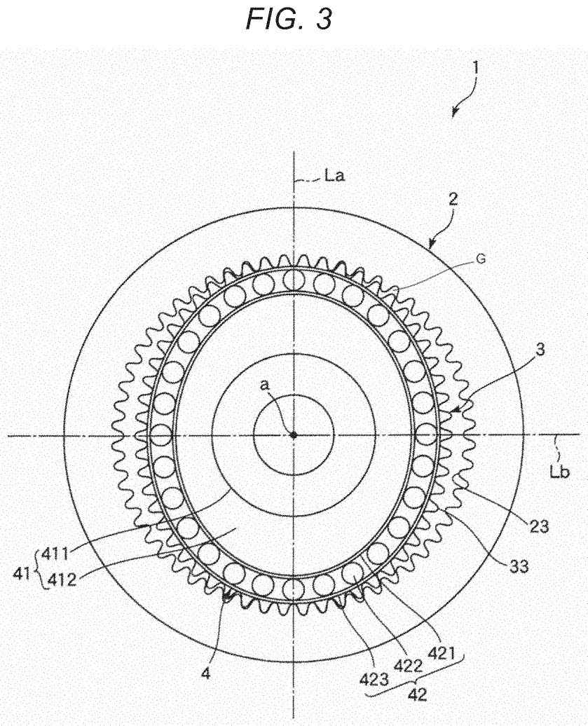

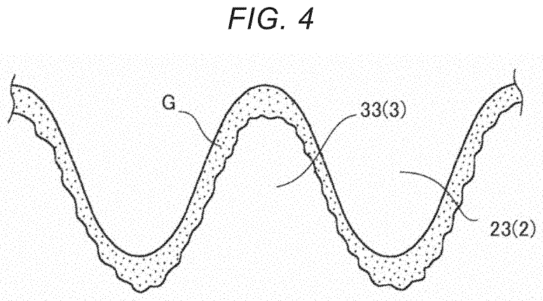

FIG. 2 is a longitudinal cross-sectional view showing a gear device according to a first embodiment of the present disclosure. FIG. 3 is a front view (a view when seen from an axial line a direction) of a body of the gear device shown in FIG. 2. FIG. 4 is a cross-sectional view showing a surface state of external teeth of a flexible gear included in the gear device shown in FIG. 2. In the respective drawings, for the sake of convenience of explanation, the dimensions of the respective portions are appropriately illustrated in an exaggerated manner as needed, and further, the dimensional ratios of the respective portions do not necessarily coincide with the actual dimensional ratios.

The gear device 10 shown in FIG. 2 is a wave gear device and is used, for example, as a speed reduction gear. This gear device 10 includes a gear device body 1 and a case 5 housing the gear device body 1, and these are integrated. Here, in the case 5 of the gear device 10, a lubricant G is disposed. Hereinafter, the respective portions of the gear device 10 will be described. Note that the case 5 may be provided as needed and may be omitted.

### Gear Device Body

The gear device body 1 includes a rigid gear 2 that is an internal gear, a flexible gear 3 that is a cup-type external gear disposed inside the rigid gear 2, and a wave generator 4 disposed inside the flexible gear 3.

In this embodiment, the rigid gear 2 is fixed (coupled) to the base stand 110 (first member) of the robot 100 described above through the case 5, the flexible gear 3 is coupled to the first arm 120 (second member) of the robot 100 described above, and the wave generator 4 is coupled to the rotating shaft of the motor 170 disposed in the base stand 110 of the robot 100 described above.

When the rotating shaft of the motor 170 rotates (that is, a driving force is generated), the wave generator 4 rotates at the same rotational speed as the rotating shaft of the motor 170. Then, the rigid gear 2 and the flexible gear 3 have mutually different numbers of teeth, and therefore, relatively rotate around the axial line a while a mutually meshing position is moving along a circumferential axis. In this embodiment, the number of teeth of the rigid gear 2 is larger than the number of teeth of the flexible gear 3, and therefore, the flexible gear 3 can be rotated at a lower rotational speed than the rotational speed of the rotating shaft of the motor 170. That is, a speed reduction gear including the wave generator 4 on the input shaft side and the flexible gear 3 on the output shaft side can be realized.

Incidentally, depending on the form of the case 5, even if the flexible gear 3 is fixed (coupled) to the base stand 110 and the rigid gear 2 is coupled to the first arm 120, the gear device 10 can be used as the speed reduction gear. Further, even if the rotating shaft of the motor 170 is coupled to the flexible gear 3, the gear device 10 can be used as the speed reduction gear, and in this case, it is only necessary that the wave generator 4 be fixed (coupled) to the base stand 110, and the rigid gear 2 be coupled to the first arm 120. Further, when the gear device 10 is used as a speed increasing gear (when the flexible gear 3 is rotated at a higher rotational speed than the rotational speed of the rotating shaft of the motor 170), the above-mentioned relationship between the input side and the output side only needs to be reversed.

As shown in FIGS. 2 and 3, the rigid gear 2 is a gear constituted by a rigid body that does not substantially bend in the radial direction and is a ring-shaped internal gear having internal teeth 23. In this embodiment, the rigid gear 2 is a spur gear. That is, the internal teeth 23 have a tooth trace parallel to the axial line a. The tooth trace of the internal teeth 23 may be inclined with respect to the axial line a. That is, the rigid gear 2 may be a helical gear or a double-helical gear.

As shown in FIGS. 2 and 3, the flexible gear 3 is inserted inside the rigid gear 2. This flexible gear 3 is a gear having flexibility capable of being flexurally deformed in the radial direction and is an external gear having external teeth 33 (teeth) meshing with some of the internal teeth 23 of the rigid gear 2. Further, the number of teeth of the flexible gear 3 is smaller than the number of teeth of the rigid gear 2. Since the flexible gear 3 and the rigid gear 2 have mutually different numbers of teeth in this manner, a speed reduction gear can be realized.

In this embodiment, the flexible gear 3 has a cup shape having an opening portion 36 in which one end in the axial line a direction (an end portion on the right side in FIG. 2) is opened, and the external teeth 33 are formed from the opening portion 36 toward the other end. Here, the flexible gear 3 includes a torso portion 31 (cylindrical portion) in a cylindrical shape (more specifically, a circular cylindrical shape) around the axial line a, and a bottom portion 32 coupled to the other end portion in the axial line a direction of the torso portion 31. According to this, the end portion of the opening portion 36 is more likely to bend in the radial direction as compared with the bottom portion 32 of the torso portion 31, and therefore, favorable deflection meshing of the flexible gear 3 with the rigid gear 2 can be realized. Further, the rigidity of the bottom portion 32 to which a shaft 62 (for example, an output shaft) is coupled can be enhanced. Due to this, the gear device 10 has a very small backlash and is suitable for use in repeating inversion, and also, since the ratio of the number of simultaneous meshing teeth is large, a force to be applied to one tooth becomes small, and a high torque capacity can also be obtained. The device can be used in such a severe application, and therefore, a lubricant is required to have high lubrication performance.

As shown in FIGS. 2 and 3, the wave generator 4 is disposed inside the flexible gear 3 and can rotate around the axial line a. Then, the wave generator 4 meshes the external teeth 33 of the flexible gear 3 with the internal teeth 23 of the rigid gear 2 by deforming the transverse plane of the opening portion 36 of the flexible gear 3 into an elliptical shape or an oval shape having a major axis La and a minor axis Lb. Here, the flexible gear 3 and the rigid gear 2 mesh with each other inside and outside rotatably around the same axial line a.

In this embodiment, the wave generator 4 includes a cam 41 and a bearing 42 fitted to the outer circumference of the cam 41. The cam 41 includes a shaft portion 411 rotating around the axial line a and a cam portion 412 projecting outward from one end portion of the shaft portion 411.

To the shaft portion 411, a shaft 61 (for example, an input shaft) is coupled. The outer circumferential face of the cam portion 412 has an elliptical shape or an oval shape when seen from a direction along the axial line a. The bearing 42 includes a flexible inner ring 421 and a flexible outer ring 423 and a plurality of balls 422 disposed between these rings. Here, the inner ring 421 is fitted in the outer circumferential face of the cam portion 412 of the cam 41 and is elastically deformed into an elliptical shape or an oval shape along the outer circumferential face of the cam portion 412. With the deformation, the outer ring 423 is also elastically deformed into an elliptical shape or an oval shape. The outer circumferential face of the inner ring 421 and the inner circumferential face of the outer ring 423 each have an orbital plane that guides and rolls the plurality of balls 422 along the circumferential axis. Further, the plurality of balls 422 are held by a holder (not shown) so as to keep the distance between each other constant in the circumferential axis. In the bearing 42, a grease (not shown) is disposed. This grease may be the same as or different from the below-mentioned lubricant G.

In such a wave generator 4, the direction of the cam portion 412 changes with the rotation of the cam 41 around the axial line a, and accompanying this, the outer circumferential face of the outer ring 423 is also deformed and the meshing position of the rigid gear 2 and the flexible gear 3 is moved along the circumferential axis.

The rigid gear 2, the flexible gear 3, and the wave generator 4 are each constituted by a metal material such as an iron-based material.

Particularly, the constituent material of the flexible gear 3 (external gear) contains nickel chromium molybdenum steel as a main material. The nickel chromium molybdenum steel becomes tough steel by being subjected to an appropriate heat treatment, and has excellent mechanical properties (particularly fatigue strength), and therefore can be said to be suitable as the constituent material of the flexible gear 3 to which repetitive stress is applied.

Examples of the nickel chromium molybdenum steel include steel materials of types specified in JIS G 4053:2016. Specific examples thereof include SNCM220, SNCM240, SNCM415, SNCM420, SNCM431, SNCM439, SNCM447, SNCM616, SNCM625, SNCM630, and SNCM815 as codes specified in the JIS standard. Among these, it is particularly preferred to use SNCM439 as the nickel chromium molybdenum steel to be used as the constituent material of the flexible gear 3 from the viewpoint of having excellent mechanical properties.

The constituent material of the flexible gear 3 may contain a material other than the nickel chromium molybdenum steel. That is, the flexible gear 3 may be constituted by a composite material obtained by combining the nickel chromium molybdenum steel with a material other than that. However, the flexible gear 3 only needs to be configured such that the percentage (mass %) of the nickel chromium molybdenum steel occupied in the total is larger than that of the material other than that, that is, the nickel chromium molybdenum steel is contained as the main material.

On the other hand, as the constituent material of the rigid gear 2 (internal gear), spheroidal graphite cast iron is contained as a main material. The spheroidal graphite cast iron is also called “ductile cast iron” and is cast iron in which graphite in a spheroidal form is crystallized. In such spheroidal graphite cast iron, graphite in a spheroidal form is dispersed in a base, and therefore, graphite hardly serves as a starting point of a crack, and thus, the strength of the base can be maximally exhibited as compared with, for example, flake graphite cast iron. As a result, the spheroidal graphite cast iron has excellent strength and toughness. Further, the spheroidal graphite cast iron has sufficient strength and toughness by being subjected to the below-mentioned heat treatment. Therefore, the life of the rigid gear 2 can be prolonged.

In the spheroidal graphite cast iron, graphite contained functions as a lubricant, and therefore, the internal teeth 23 of the rigid gear 2 are hardly adhered. Due to this, the abrasion of the rigid gear 2 can be further reduced.

In addition, the spheroidal graphite cast iron converts transmitted vibration to thermal energy at a boundary between the graphite and the base and can eliminate the vibration. Therefore, vibration or noise generated in the rigid gear 2 can be reduced.

Further, the spheroidal graphite cast iron has high thermal conductivity and therefore has excellent heat dissipation. Due to this, the heat dissipation of the rigid gear 2 is also enhanced so as to be able to prevent the temperature of the rigid gear 2 from becoming extremely high, and thus, the life of the gear device 10 can be prolonged.

The life of the gear device 10 refers to, for example, a period from the start of use of the gear device 10 to the occurrence of damage in any portion of the gear device 10. Examples of such damage include rupture of the rigid gear 2 or the flexible gear 3.

Examples of the spheroidal graphite cast iron include materials of types specified in JIS G 5502:2001. Specific examples thereof include FCD350-22, FCD350-22L, FCD400-18, FCD400-18L, FCD400-15, FCD400-10, FCD450-10, FCD500-7, FCD600-3, FCD700-2, and FCD800-2 as codes specified in the JIS standard.

Examples of the alloy composition of the spheroidal graphite cast iron include a composition containing Fe (iron) as a main component and also containing C (carbon) at 2.0 mass % or more and 6.0 mass % or less, Si (silicon) at 0.5 mass % or more and 3.5 mass % or less, and Mn (manganese) at 0.4 mass % or more and 1.0 mass % or less. In the spheroidal graphite cast iron, further, Cu (copper), Ni (nickel), Cr (chromium), Sn (tin), Mg (magnesium), or the like may be contained.

The constituent material of the rigid gear 2 is spheroidal graphite cast iron having been subjected to quenching and tempering treatment or spheroidal graphite cast iron having been subjected to austempering treatment.

By subjecting the spheroidal graphite cast iron to quenching and tempering treatment, the base structure can be converted from a martensite structure to a mixed structure of fine cementite (Fe3C) and ferrite (a solid solution), and can be particularly preferably converted to a sorbite structure. Therefore, the constituent material of the rigid gear 2 preferably includes a sorbite structure in the base in which graphite is dispersed, that is, includes spheroidal graphite cast iron including a sorbite structure. According to this, favorable toughness and elongation can be imparted to the spheroidal graphite cast iron while maintaining the mechanical strength, and the rigid gear 2 having particularly favorable durability can be realized.

The sorbite structure refers to a structure, which is a mixed structure of fine cementite and ferrite, and in which the fine cementite is in a granular form. At that time, the cementite in a granular form is regarded as a structure in which at least a part has a size to such an extent that it is recognized by light microscopy at a magnification of 400 times. By including the cementite structure that has such a moderate grain diameter and is in a granular (spherical) form, the sorbite structure contributes to realization of the rigid gear 2 having particularly favorable toughness and elongation. A structure other than the sorbite structure may be mixed in the base.

The tensile strength of the spheroidal graphite cast iron including such a sorbite structure is not particularly limited, but is preferably 600 MPa or more, more preferably 650 MPa or more and 1200 MPa or less. According to this, the gear device 10 having a particularly prolonged life can be realized.

In the measurement of the tensile strength, for example, a JIS 14A specimen is used, and a value obtained by dividing the maximum load (rupture load) that the specimen withstood by the cross-sectional area of a parallel portion of the specimen is determined to be the tensile strength.

Further, the elongation of the spheroidal graphite cast iron including such a sorbite structure is not particularly limited, but is preferably 10% or more, more preferably 12% or more and 25% or less. According to this, the gear device 10 having a particularly prolonged life can be realized.

In the measurement of the elongation, for example, a JIS 14B specimen is used, and the maximum elongation until the specimen is ruptured (elongation at rupture) is determined to be the elongation.

Further, by subjecting the spheroidal graphite cast iron to austempering treatment in place of the above-mentioned quenching and tempering treatment, the base structure can be converted to a bainite structure. Therefore, the constituent material of the rigid gear 2 preferably includes a bainite structure in the base in which graphite is dispersed, that is, includes spheroidal graphite cast iron including a bainite structure. According to this, favorable toughness can be imparted to the spheroidal graphite cast iron while maintaining the mechanical strength, and the rigid gear 2 having particularly favorable durability can be realized.

The bainite structure refers to a structure formed by heating steel to an austenitizing temperature (for example, about 820° C. or higher and 900° C. or lower) and then subjecting the steel to austempering treatment (isothermal transformation treatment), and generally includes an acicular structure. Such a bainite structure contributes to realization of the rigid gear 2 having particularly favorable mechanical strength. A structure other than the bainite structure may be mixed in the base.

The tensile strength of the spheroidal graphite cast iron including such a bainite structure is not particularly limited, but is preferably 700 MPa or more, more preferably 800 MPa or more and 1250 MPa or less. According to this, the gear device 10 having a particularly prolonged life can be realized. The measurement method for the tensile strength is the same as the above-mentioned method.

Further, the elongation of the spheroidal graphite cast iron including such a bainite structure is not particularly limited, but is preferably 1% or more, more preferably 2% or more and 10% or less. According to this, the gear device 10 having a particularly prolonged life can be realized. The measurement method for the elongation is the same as the above-mentioned method.

Further, particularly from the viewpoint of fatigue strength, the spheroidal graphite cast iron including a sorbite structure is more preferred than the spheroidal graphite cast iron including a bainite structure. According to this, the gear device 10 having a more particularly prolonged life can be realized.

As described above, by using the spheroidal graphite cast iron having been subjected to quenching and tempering treatment or the spheroidal graphite cast iron having been subjected to austempering treatment, the gear device 10 having a particularly prolonged life can be realized.

Further, the constituent material of the rigid gear 2 may contain a material other than the spheroidal graphite cast iron having been subjected to quenching and tempering treatment or the spheroidal graphite cast iron having been subjected to austempering treatment. That is, the rigid gear 2 may be constituted by a composite material obtained by combining the spheroidal graphite cast iron having been subjected to quenching and tempering treatment or the spheroidal graphite cast iron having been subjected to austempering treatment with a material other than that. However, the rigid gear 2 only needs to be configured such that the percentage (mass %) of the spheroidal graphite cast iron having been subjected to quenching and tempering treatment or the spheroidal graphite cast iron having been subjected to austempering treatment occupied in the total is larger than that of the material other than that, that is, the spheroidal graphite cast iron having been subjected to quenching and tempering treatment or the spheroidal graphite cast iron having been subjected to austempering treatment is contained as the main material.

The Vickers hardness of the surface of the rigid gear 2 (internal gear) is equal to or less than the Vickers hardness of the surface of the flexible gear 3 (external gear). According to this, the surfaces of the internal teeth 23 of the rigid gear 2 are moderately abraded, and therefore, graphite derived from the spheroidal graphite cast iron contained in the rigid gear 2 is exposed, and the lubricity of the surfaces of the internal teeth 23 is improved thereby. As a result, abrasion accompanying the adhesion of the surfaces of the external teeth 33 of the flexible gear 3 on the surfaces of the internal teeth 23 of the rigid gear 2 is less likely to occur, and the life of the gear device 10 can be prolonged.

The Vickers hardness is measured according to the Vickers hardness test—Test method specified in JIS Z 2244:2009. A test force applied by an indenter is set to 9.8 N (1 kgf), and the holding time of the test force is set to 15 seconds. Then, an average of the measurement results at 10 sites is determined to be the Vickers hardness.

The Vickers hardness of the surface of the flexible gear 3 (external gear) is preferably within a range of 400 or more and 520 or less, more preferably within a range of 450 or more and 520 or less. According to this, the balance between the mechanical strength and the toughness of the flexible gear 3 is achieved, and the life of the flexible gear 3 can be favorably prolonged. When the Vickers hardness is too low, the strength of the flexible gear 3 is not sufficient, and there is a fear that the flexible gear 3 cannot withstand load stress and is easily destroyed. On the other hand, when the Vickers hardness is too high, the toughness of the flexible gear 3 is decreased, and the flexible gear 3 tends to be easily destroyed by an impact or the like, and also abrasion of the rigid gear 2 is made to excessively proceed and the durability of the gear device 10 may be decreased.

The Vickers hardness of the surface of the rigid gear 2 (internal gear) is preferably within a range of 300 or more and 450 or less, more preferably within a range of 320 or more and 400 or less. According to this, the balance between the mechanical strength and the toughness of the rigid gear 2 is achieved, and the life of the rigid gear 2 can be favorably prolonged. When the Vickers hardness is too low, there is a fear that abrasion of the rigid gear 2 excessively proceeds and the transmission efficiency of the gear device 10 is decreased. There is also a fear that the rigid gear 2 cannot withstand load stress and is easily destroyed. On the other hand, when the Vickers hardness is too high, an impact when the rigid gear 2 and the flexible gear 3 mesh with each other is increased, and there is a fear that the flexible gear 3 is destroyed or the durability of the gear device 10 is decreased.

Further, it is preferred that compressive residual stress is applied to at least the surfaces of the external teeth 33 of the flexible gear 3. According to this, the fatigue strength of the external teeth 33 is improved, and the flexible gear 3 that can also withstand high load stress can be realized, and as a result, the durability of the gear device 10 can be improved.

Here, in order to obtain the effect as described above, the residual stress (compressive residual stress) of the flexible gear 3 is preferably within a range of −950 MPa or more and −450 MPa or less, more preferably within a range of −950 MPa or more and −550 MPa or less, further more preferably within a range of −950 MPa or more and −750 MPa or less. When the absolute value of the residual stress is too small, the above-mentioned effect tends to decrease. On the other hand, when the absolute value of the residual stress is too large, deformation of the external teeth 33 accompanying the application of the residual stress becomes too large, and appropriate operation of the gear device 10 tends to become difficult.

Further, such compressive residual stress can be applied by subjecting the surface of the flexible gear 3 to shot peening. By subjecting the surface of the flexible gear 3 to shot peening in this manner, fine irregularities are formed on the surface of the flexible gear 3 as shown in FIG. 4. According to this, retention of the lubricant G on the surface of the flexible gear 3 can be facilitated. As a result, the durability of the gear device 10 can be improved.

Here, a surface roughness Ra1 of the external teeth of the flexible gear 3 (external gear) is preferably within a range of 0.2 μm or more and 1.6 μm or less, more preferably within a range of 0.2 μm or more and 0.8 μm or less. According to this, retention of the grease (lubricant G) on the external teeth 33 of the flexible gear 3 is facilitated while reducing abrasion of the rigid gear 2, and the life of the flexible gear 3 and the rigid gear 2 can be favorably prolonged. When the surface roughness is too small, the effect of facilitating retention of the grease (lubricant G) on the external teeth 33 of the flexible gear 3 tends to become small. On the other hand, when the surface roughness is too large, the contact resistance of the tooth faces of the external teeth 33 becomes large, and the efficiency of the gear device 10 is decreased and also the rigid gear 2 is easily abraded, and the durability of the gear device 10 tends to be decreased. The surface roughness Ra1 is an arithmetic average roughness Ra of the external teeth 33 and is measured according to the method specified in JIS B 0601:2013.

Further, the surface roughness Ra1 of the external teeth 33 of the flexible gear 3 (external gear) is preferably larger than a surface roughness Ra2 of the internal teeth 23 of the rigid gear 2 (internal gear). According to this, while facilitating retention of the grease (lubricant G) on the external teeth 33 of the flexible gear 3, the contact resistance between the flexible gear 3 and the rigid gear 2 is reduced, and the life of the flexible gear 3 and the rigid gear 2 can be favorably prolonged.

On the other hand, the surface roughness Ra2 of the internal teeth 23 of the rigid gear 2 (internal gear) is preferably within a range of 0.1 μm or more and 0.8 μm or less, more preferably within a range of 0.1 μm or more and 0.4 μm or less. According to this, while reducing the production cost of the rigid gear 2, the contact resistance between the flexible gear 3 and the rigid gear 2 can be reduced. When the surface roughness is too small, the effect of improving efficiency is small although the cost for finishing the tooth-shaped surfaces of the internal teeth 23 is increased. On the other hand, when the surface roughness is too large, the contact resistance of the tooth faces of the internal teeth 23 becomes large, and the efficiency of the gear device 10 tends to decrease. The surface roughness Ra2 is an arithmetic average roughness Ra of the internal teeth 23 and is measured according to the method specified in JIS B 0601:2013.

Further, the average crystal grain diameter of the constituent material of the flexible gear 3 (external gear) is preferably smaller than the average crystal grain diameter of the constituent material of the rigid gear 2 (internal gear). By having such a magnitude relationship of the average crystal grain diameter of the constituent materials of the internal teeth 23 and the external teeth 33, the crystal grain diameter of the external teeth 33 can be made small so as to be able to facilitate retention of the lubricant G on the external teeth 33. Accordingly, the lubricant G can be retained on the external teeth 33 against the centrifugal force by rotation of the external teeth 33. Here, the lubricant G is preferentially retained at a crystal grain boundary present on the surfaces of the external teeth 33. This is considered to be because the crystal grain boundary plays a role as a fine recess or groove storing the lubricant G. Therefore, by decreasing the crystal grain diameter of the external teeth 33, the density of the crystal grain boundary present on the surfaces of the external teeth 33 is increased, and accompanying this, the lubricant G is easily retained on the surfaces of the external teeth 33.

Further, by decreasing the crystal grain diameter of the external teeth 33, the mechanical strength of the external teeth 33 can be increased, and also the toughness of the external teeth 33 can be increased. The external teeth 33 repeats deformation with the movement of the meshing position of the rigid gear 2 and the flexible gear 3 as described above, and therefore, the external teeth 33 is required to have higher mechanical strength and toughness as compared with the internal teeth 23. Due to this, the increase in the mechanical strength and toughness of the external teeth 33 is extremely useful. The mechanical strength of a metal generally increases in inverse proportional to the ½ power of the crystal grain diameter.

On the other hand, by the magnitude relationship of the average crystal grain diameter of the constituent materials of the internal teeth 23 and the external teeth 33 as described above, the crystal grain diameter of the internal teeth 23 can be made large so as to be able to facilitate flow of the lubricant G along on the internal teeth 23. Therefore, uneven distribution or solidification of the lubricant G on the internal teeth 23 can be reduced. Here, since the internal teeth 23 do not rotate, a centrifugal force as in the case of the external teeth 33 described above does not work on the internal teeth 23, and therefore, the lubricant G tends to be easily retained on the internal teeth 23 from the beginning. Therefore, by facilitating flow of the lubricant G on the internal teeth 23, adhesion of the lubricant G or oil shortage in a place where the oil is needed is prevented. Accordingly, the performance of the lubricant G can be sufficiently exhibited.

In this manner, the gear device 10 can simultaneously exhibit two effects: an effect of retaining the lubricant G on the external teeth 33; and an effect of reducing uneven distribution or solidification of the lubricant G on the internal teeth 23 as described above. Then, by multiplication of these two effects, the lubrication life of the lubricant G can be effectively improved. In particular, in a wave gear device such as the gear device 10, an internal gear and an external gear generally mesh with each other with an extremely small backlash, and therefore, a demand for the lubrication life of a lubricant is extremely high. Due to this, when applying the present disclosure to such a gear device, the effects become remarkable.

Here, the “average crystal grain diameter” is measured according to “Steels—Micrographic determination of the apparent grain size” in JIS G 0551:2013. When measuring this average crystal grain diameter, a crystal grain boundary is exposed by etching the surface of a specimen (an internal tooth or an external tooth) with an etching solution, and the measurement is carried out by microscopic observation of the exposed crystal grain boundary, and as the etching solution, 5% Nital (5% nitric acid-ethyl alcohol) or an etching solution based on an aqueous picric acid solution (2% picric acid-0.2% sodium chloride-0.1% sulfuric acid-distilled water) is used. Further, the magnitude relationship of the average crystal grain diameter as described above only needs to be satisfied at least between the internal teeth 23 and the external teeth 33 and may not be satisfied between the other portions of the rigid gear 2 and the flexible gear 3, however, when the magnitude relationship is also satisfied between the other portions, the effect becomes remarkable. Further, the crystal grain diameters of the internal teeth 23 and the external teeth 33 can be adjusted, for example, according to the materials constituting these (metal compositions), the heat treatment during production, etc.

When the average crystal grain diameter of the constituent material of the external teeth 33 is represented by A and the average crystal grain diameter of the constituent material of the internal teeth 23 is represented by B, A and B only need to satisfy the relationship: A<B as described above, but preferably satisfy the relationship: 1.2≤B/A≤100, more preferably satisfy the relationship: 2≤B/A≤50 in order to favorably exhibit the two effects as described above. When B/A is too small, the balance between the above-mentioned two effects tends to deteriorate, and on the other hand, when B/A is too large, the difference in strength between the internal teeth 23 and the external teeth 33 becomes too large, and abrasion of either of the internal teeth 23 and the external teeth 33 tends to accelerate.

The average crystal grain diameter of the constituent material of the internal teeth 23 is preferably within a range of 20 μm or more and 150 μm or less, more preferably within a range of 30 μm or more and 100 μm or less, further more preferably within a range of 30 μm or more and 50 μm or less. According to this, the lubricant G can be made more effectively to flow along on the internal teeth 23. Further, when the internal teeth 23 are constituted by a metal, the mechanical strength of the internal teeth 23 can be made excellent. When the average crystal grain diameter is too small, the fluidity of the lubricant G on the internal teeth 23 tends to decrease. On the other hand, when the average crystal grain diameter is too large, the strength of the internal teeth 23 may be insufficient depending on the constituent material of the internal teeth 23. When the average crystal grain diameter satisfies the above-mentioned range in the whole rigid gear 2, the above-mentioned effects become remarkable.

On the other hand, the average crystal grain diameter of the constituent material of the external teeth 33 is preferably within a range of 0.5 μm or more and 30 μm or less, more preferably within a range of 5 μm or more and 20 μm or less, further more preferably within a range of 5 μm or more and 15 μm or less. According to this, the lubricant G can be more effectively retained on the external teeth 33. Further, when the external teeth 33 are constituted by a metal, the mechanical strength of the external teeth 33 can be made excellent. When the average crystal grain diameter is too small, the workability when producing the external teeth 33 is poor, and also the depth of a recess caused by a crystal grain boundary present on the surface of the external teeth 33 also becomes small, and therefore, it becomes difficult to retain the lubricant G on the external teeth 33 instead. On the other hand, when the average crystal grain diameter is too large, the effect of retaining the lubricant G on the external teeth 33 tends to decrease, and also it is difficult to ensure mechanical strength and toughness necessary for the external teeth 33. When the average crystal grain diameter satisfies the above-mentioned range in the whole flexible gear 3, the above-mentioned effects become remarkable.

In the constituent material of the flexible gear 3 and the constituent material of the rigid gear 2, a material other than the above-mentioned material may be added in an amount within a range of 0.01 mass % or more and 2 mass % or less. In particular, the constituent material of the flexible gear 3 (external gear) preferably contains a Group 4 element or a Group 5 element in an amount within a range of 0.01 mass % or more and 0.5 mass % or less. According to this, even if a heat treatment is performed in the process for producing the flexible gear 3, the growth of the crystal grain of an iron-based material constituting the flexible gear 3 is suppressed so that the crystal grain diameter can be made small. Therefore, the mechanical strength of the flexible gear 3 can be improved. Further, according to the gear device 10 including such a flexible gear 3, the mechanical strength of the flexible gear 3 is improved, and therefore, the durability of the gear device 10 can be improved.

As the additive element, it is only necessary to use a Group 4 element or a Group 5 element as described above, however, it is preferred to use one type alone or two or more types in combination among titanium (Ti), zirconium (Zr), hafnium (Hf), vanadium (V), niobium (Nb), and tantalum (Ta), it is more preferred to contain at least one of zirconium (Zr) and niobium (Nb), and it is further more preferred to contain both zirconium (Zr) and niobium (Nb). According to this, the effect of suppressing the growth of the crystal grain of the iron-based material constituting the flexible gear 3 (hereinafter also referred to as “crystal grain growth suppressing effect”) can be more effectively exhibited. In the constituent material of the flexible gear 3, an element other than the Group 4 element or the Group 5 element may be contained, and for example, from the viewpoint of effectively suppressing the growth of the crystal grain of the iron-based material constituting the flexible gear 3, yttrium (Y) may be contained.

The content (addition amount) of the additive element in the constituent material of the flexible gear 3 is preferably within a range of 0.05 mass % or more and 0.3 mass % or less, more preferably within a range of 0.1 mass % or more and 0.2 mass % or less. According to this, the crystal grain growth suppressing effect can be more effectively exhibited. When the content is too small, there is a fear that the crystal grain growth suppressing effect is significantly decreased. On the other hand, when the content is too large, not only no further crystal grain growth suppressing effect can be obtained, but also there is a fear that the toughness of the flexible gear 3 is decreased, and the mechanical strength of the flexible gear 3 is decreased instead or the workability when producing the flexible gear 3 is extremely deteriorated.

### Case

The case 5 shown in FIG. 2 includes a substantially plate-shaped lid 11 supporting a shaft 61 (for example, an input shaft) through a bearing 13 and a cup-shaped body 12 supporting a shaft 62 (for example, an output shaft) through a bearing 14. Here, the lid 11 and the body 12 are coupled (fixed) to each other to form a space, and in this space, the gear device body 1 described above is housed. Further, to at least one of the lid 11 and the body 12, the rigid gear 2 of the gear device body 1 described above is fixed through, for example, a screw clamp or the like.

An inner wall face 111 of the lid 11 has a shape spreading in a direction perpendicular to the axial line a so as to cover the opening portion 36 of the flexible gear 3. Further, an inner wall face 121 of the body 12 has a shape along an outer circumferential face and a bottom face of the flexible gear 3. Such a case 5 is fixed to the base stand 110 of the robot 100 described above. Here, the lid 11 may be a separate body from the base stand 110 and fixed to the base stand 110 through, for example, a screw clamp or the like, or may be integrated with the base stand 110. Further, the constituent material of the case 5 (the lid 11 and the body 12) is not particularly limited, however, for example, a metal material, a ceramic material, and the like are exemplified.

### Lubricant

The lubricant G is, for example, a grease (semisolid lubricant) and is disposed in at least either of a portion between the rigid gear 2 and the flexible gear 3 (a meshing portion) that is a lubrication target portion and a portion between the flexible gear 3 and the wave generator 4 (a contact portion and a sliding portion) that is a lubrication target portion (hereinafter also simply referred to as “lubrication target portion”). According to this, friction in the lubrication target portion can be reduced.

In this manner, the gear device 10 includes the lubricant G disposed between the rigid gear 2 (internal gear) and the flexible gear 3 (external gear). This lubricant G contains a base oil, a thickener, and an organic molybdenum compound and preferably has an oil separation degree within a range of 4 mass % or more and 13.8 mass % or less. Since the lubricant G contains the organic molybdenum compound, friction in the meshing portion of the rigid gear 2 and the flexible gear 3 can be effectively reduced. In addition, since the oil separation degree of the lubricant G is within a range of 4 mass % or more and 13.8 mass % or less, even if the lubricant G contains the organic molybdenum compound, seepage of the base oil from the thickener is hardly inhibited, and the base oil can be stably supplied to the contact portion of the flexible gear 3 and the wave generator 4. As a result, the life of the flexible gear 3 and the rigid gear 2 can be favorably prolonged.

Examples of the base oil include mineral oils (refined mineral oils) such as paraffin-based and naphthene-based oils, and synthetic oils such as polyolefins, esters, and silicones, and it is possible to use one type alone or two or more types in combination among these. Examples of the thickener include soap-based thickeners such as calcium soaps, calcium complex soaps, sodium soaps, aluminum soaps, lithium soaps, and lithium complex soaps, and non-soap-based thickeners such as polyurea, sodium terephthalate, polytetrafluoroethylene (PTFE), organic bentonite, and silica gel, and it is possible to use one type alone or two or more types in combination among these. The lubricant G (grease) containing a base oil and a thickener as a composition in this manner holds the base oil by intricately intertwining a three-dimensional structure formed by the thickener and exhibits a lubrication action by allowing the held base oil to gradually seep out.

It is preferred that the content of the base oil in the lubricant G is 75 mass % or more and 85 mass % or less, and the content of the thickener in the lubricant G is 10 mass % or more and 20 mass % or less. According to this, the lubrication performance of the lubricant G can be enhanced.

The organic molybdenum compound functions as a solid lubricant or an extreme pressure agent. According to this, friction in the lubrication target portion can be effectively reduced, and even if the lubrication target portion becomes in an extreme pressure lubricating state, seizure or scuffing can be effectively prevented. In particular, the organic molybdenum compound exhibits an extreme pressure property and abrasion resistance equivalent to those of molybdenum disulfide, and moreover has excellent oxidation stability as compared with molybdenum disulfide. Therefore, the life of the lubricant G can be prolonged.

Here, the organic molybdenum compound in a granular state is added to the lubricant G, however, when the compound is used in the gear device 10, it forms a coating film on the lubrication target portion by being subjected to a decomposition reaction, and therefore has an effect of decreasing the friction coefficient. Due to this, the organic molybdenum compound is suitable for lubrication in the meshing portion of the rigid gear 2 and the flexible gear 3 meshing with each other with an extremely small backlash or in an extremely small gap between the flexible gear 3 and the wave generator 4. On the other hand, in the case of molybdenum disulfide, in order to reduce friction in the lubrication target portion, even if the lubricant is adhered to the lubrication target portion, the granular state should be maintained, and therefore, it is hard to say that molybdenum disulfide is suitable for lubrication in the meshing portion of the rigid gear 2 and the flexible gear 3 or in the contact portion of the flexible gear 3 and the wave generator 4.

The content of the organic molybdenum compound in the lubricant G is preferably, for example, 1 mass % or more and 5 mass % or less. According to this, the performance of the organic molybdenum compound as the extreme pressure agent is easily exhibited, and the improvement of the property of the lubricant G becomes remarkable. As the extreme pressure agent or the solid lubricant, another extreme pressure agent such as zinc dialkyldithiophosphate may be used in combination other than the organic molybdenum compound.

The average grain diameter of the organic molybdenum compound is generally about 10 μm and is relatively large. Therefore, when the organic molybdenum compound is simply added to the lubricant G, due to the effect of the grain of the organic molybdenum compound, seepage of the base oil from the thickener of the lubricant G is inhibited and reduced, and lack of lubrication in the lubrication target portion may sometimes be caused. For example, the contact portion of the flexible gear 3 and the wave generator 4 has a small gap, and therefore, it is difficult to supply the entire grease thereto, and it is important to supply the base oil seeping from the thickener, and thus, lack of lubrication is likely to be caused.

Therefore, the oil separation degree of the lubricant G is preferably within a range of 4 mass % or more and 13.8 mass % or less, more preferably within a range of 6 mass % or more and 11 mass % or less, further more preferably within a range of 6 mass % or more and 10 mass % or less. According to this, seepage of the base oil from the thickener of the lubricant G is hardly inhibited, and the base oil can be stably supplied to the lubrication target portion (particularly, the contact portion of the flexible gear 3 and the wave generator 4). In this manner, the lubricant G can stably supply the base oil to the lubrication target portion by seepage of the base oil from the thickener while allowing the organic molybdenum compound to exhibit an excellent friction reducing effect, and as a result, the life of the gear device 10 can be prolonged. The “oil separation degree” is an index indicating an ability to allow the base oil to seep from the thickener and is measured according to the measurement method specified in JIS K 2220:2013.

From the viewpoint of enhancing the effect of the oil separation degree of the lubricant G as described above, the average grain diameter of the organic molybdenum compound (the solid lubricant or the extreme pressure agent) to be added to the lubricant G is preferably within a range of 1 or more and 10 μm or less.

Further, the oil separation degree tends to increase as the consistency increases (that is, the softness increases), and has a correlation with the consistency to some extent. Therefore, for example, by adjusting the consistency according to the blending ratio of the base oil and the thickener, the lubricant G having a desired oil separation degree can be obtained.

The consistency of the lubricant G is preferably within a range of 280 or more and 400 or less, more preferably within a range of 300 or more and 380 or less, further more preferably within a range of 325 or more and 365 or less. According to this, the lubricant G can be easily retained in the lubrication target portion. Further, there is also an advantage that the oil separation degree of the lubricant G can easily be made to fall within the above-mentioned range. When the consistency of the lubricant G is too small, it is difficult to select the base oil and the thickener capable of achieving the oil separation degree within the above-mentioned range, and also the fluidity of the lubricant G is insufficient, and there is a fear that it becomes difficult to sufficiently supply the lubricant G to the meshing portion of the rigid gear 2 and the flexible gear 3. On the other hand, when the consistency of the lubricant G is too large, the fluidity of the lubricant G becomes excessively high and the lubricant G is likely to leak outside the gear device 10 (for example, at an undesired position in the case 5 or outside the case 5), and therefore, there is a fear that the supply of the lubricant G to the meshing portion of the rigid gear 2 and the flexible gear 3 becomes unstable and lubrication failure in the meshing portion is likely to occur instead. The “consistency” is an index indicating the hardness of the grease and is measured according to the measurement method specified in JIS K 2220:2013.

The dropping point of the lubricant G is preferably within a range of 248° C. or higher and 270° C. or lower. According to this, the heat resistance of the lubricant G can be made excellent while optimizing the consistency of the lubricant G. The “dropping point” refers to a temperature when a grease structure is destroyed and the lubricant changes from a semi-solid to a liquid and is measured according to the measurement method specified in JIS K 2220:2013.

As the thickener to be used in the lubricant G, it is preferred to use a lithium complex soap among the thickeners described above. According to this, the dropping point of the lubricant G can be increased, and the heat resistance of the lubricant G can be made excellent. When a lithium complex soap is used as the thickener, the lithium complex soap may be used alone as the thickener, or may be used by mixing the lithium complex soap with another thickener. When the lithium complex soap is used by mixing it with another thickener, the content of the lithium complex soap in the whole thickener is preferably 70 mass % or more.

The lubricant G may contain an additive such as an antioxidant or an antirust other than the above-mentioned base oil, thickener, and extreme pressure agent (organic molybdenum compound), and may also contain a solid lubricant such as graphite, molybdenum disulfide, or polytetrafluoroethylene (PTFE), or the like.

As described above, the gear device 10 includes the rigid gear 2 that is an internal gear, the flexible gear 3 that is an external gear having flexibility and partially meshing with the rigid gear 2, and the wave generator 4 that is in contact with an inner circumferential face of the flexible gear 3 and moves a meshing position of the rigid gear 2 and the flexible gear 3 along a circumferential axis. The flexible gear 3 contains nickel chromium molybdenum steel as a main material, and the rigid gear 2 contains spheroidal graphite cast iron having been subjected to quenching and tempering treatment or spheroidal graphite cast iron having been subjected to austempering treatment as a main material.

According to such a gear device 10, the constituent material of the flexible gear 3 contains nickel chromium molybdenum steel, and therefore, the mechanical properties (particularly fatigue strength) of the flexible gear 3 are enhanced, and the life of the flexible gear 3 can be prolonged. On the other hand, the constituent material of the rigid gear 2 contains spheroidal graphite cast iron having been subjected to quenching and tempering treatment or spheroidal graphite cast iron having been subjected to austempering treatment, and therefore, durability is imparted to the rigid gear 2, and the life of the rigid gear can be prolonged. By prolonging the life of both the flexible gear 3 and the rigid gear 2 in this manner, the life of the gear device 10 can be prolonged. Further, the acceptable range of the torque that can be input can be expanded, and therefore, the torque of the gear device 10 can be increased.

The robot 100 includes the base stand 110 that is the first member, the first arm 120 that is the second member pivoting with respect to the base stand 110, the gear device 10 transmitting a driving force for relatively pivoting the first arm 120 with respect to the base stand 110, and the motor 170 that is a driving source outputting a driving force to the gear device 10 as described above. Then, one of the rigid gear 2, the flexible gear 3, and the wave generator 4 is coupled to the base stand 110 (first member), and one of the rest is coupled to the first arm 120 (second member).

According to this, due to the prolongation of the life of the gear device 10, the life of the robot 100 can also be prolonged. Further, the frequency of replacement or repair of the gear device 10 can be decreased, and therefore, the substantial operating time of the robot 100 can be ensured longer, and thus, the work efficiency of the robot 100 can be enhanced.

### Second Embodiment

Next, a second embodiment of the present disclosure will be described.

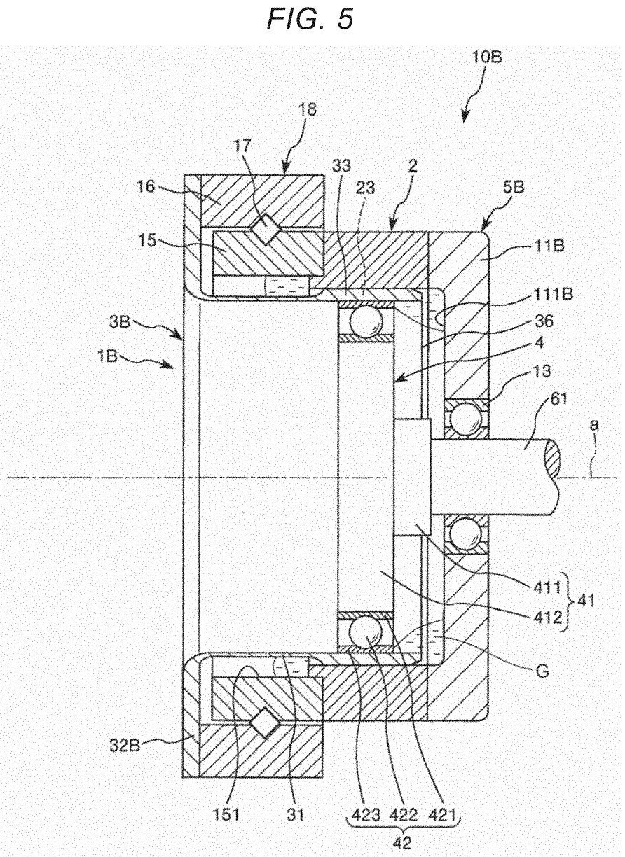

FIG. 5 is a longitudinal cross-sectional view showing a gear device according to the second embodiment of the present disclosure.

This embodiment is the same as the above-mentioned first embodiment except that the configuration of the external gear and the configuration of the case associated therewith are different. In the following description, with respect to this embodiment, different points from the above-mentioned embodiment will be mainly described, and the description of the same matter will be omitted. Further, in FIG. 5, components similar to those of the above-mentioned embodiment are denoted by the same reference numerals.

A gear device 10B shown in FIG. 5 includes a gear device body 1B and a case 5B housing the gear device body 1B. The case 5B may be omitted.

The gear device 10B includes a flexible gear 3B that is a hat-type (a brimmed head covering-type) external gear disposed inside a rigid gear 2. This flexible gear 3B includes a flange portion 32B (a coupling portion) coupled to one end portion of a cylindrical torso portion 31 and projecting to the opposite side to an axial line a. To the flange portion 32B, an output shaft (not shown) is attached.

The case 5B includes a substantially plate-shaped lid 11B supporting a shaft 61 (for example, an input shaft) through a bearing 13 and a cross-roller bearing 18 attached to the flange portion 32B of the flexible gear 3B described above.

Here, the lid 11B is fixed to one side face (on the right side in FIG. 5) of the rigid gear 2 through, for example, a screw clamp or the like. Further, the cross-roller bearing 18 includes an inner ring 15, an outer ring 16, and a plurality of rollers 17 disposed between these rings. The inner ring 15 is provided along the outer circumference of the torso portion 31 of the flexible gear 3B and fixed to the other side face (on the left side in FIG. 5) of the rigid gear 2 through, for example, a screw clamp or the like. On the other hand, the outer ring 16 is fixed to a face on the side of the torso portion 31 of the flange portion 32B of the flexible gear 3B described above through, for example, a screw clamp or the like.

Further, an inner wall face 111B of the lid 11B has a shape spreading in a direction perpendicular to the axial line a so as to cover an opening portion 36 of the flexible gear 3B. Further, an inner wall face 151 of the inner ring 15 of the cross-roller bearing 18 has a shape along an outer circumferential face of the torso portion 31 of the flexible gear 3B.

The gear device 10B as described above includes a lubricant G disposed in at least either of a portion between the rigid gear 2 and the flexible gear 3B and a portion between the flexible gear 3B and the wave generator 4 (a lubrication target portion). Here, one member of the rigid gear 2, the flexible gear 3B, and a wave generator 4 (which is the rigid gear 2 in this embodiment, but may be the flexible gear 3B or the wave generator 4) is coupled to a base stand 110 (first member), and one member of the rest (which is the flexible gear 3B in this embodiment, but may be the rigid gear 2 or the wave generator 4) is coupled to a first arm 120 (second member).

According also to the second embodiment as described above, the same effect as that of the first embodiment described above can be exhibited.

### 3. Method for Producing Gear Device

Hereinafter, an embodiment of the method for producing a gear device according to the present disclosure will be described.

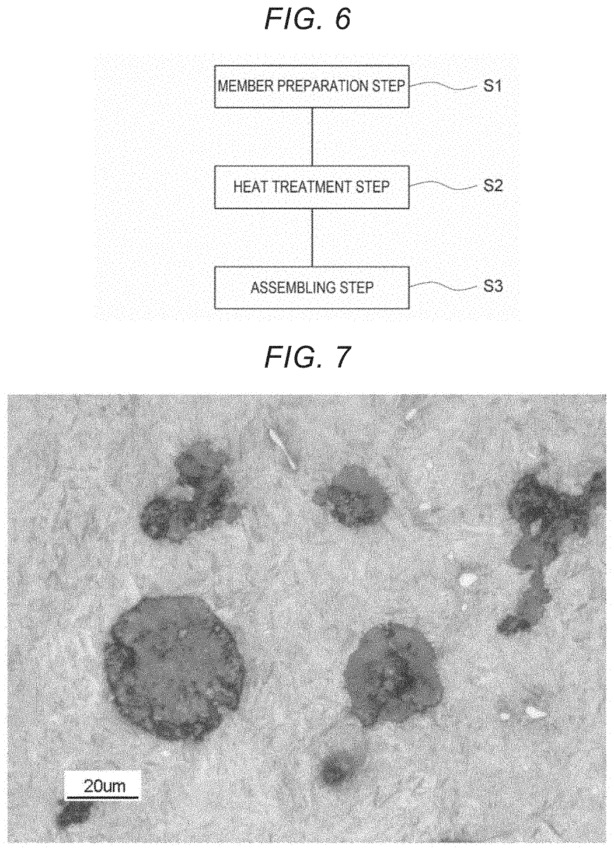

FIG. 6 is a process chart showing the embodiment of the method for producing a gear device according to the present disclosure.

The method for producing a gear device according to this embodiment includes a member preparation step of preparing a member for an internal gear containing spheroidal graphite cast iron as a main material, and a heat treatment step of subjecting the member for an internal gear to quenching and tempering treatment or austempering treatment, thereby obtaining an internal gear. Hereinafter, the respective steps will be described.

### [1] Member Preparation Step S1

First, a member for an internal gear constituted by a material containing spheroidal graphite cast iron is prepared. The member for an internal gear may be produced by any method. Further, the member for an internal gear is molded into a shape of the above-mentioned rigid gear 2.

The spheroidal graphite cast iron contained in the member for an internal gear is mainly constituted by graphite in a granular form and a base, however, the base among these preferably includes a pearlite structure. The pearlite structure refers to a cementite structure in a layered form and contains iron carbide as a main component. The “layered form” refers to a state where an aspect ratio defined by the major axis/the minor axis of a crystal structure is, for example, 5 or more. By including such a pearlite structure in the base, when spheroidal graphite cast iron is subjected to the below-mentioned quenching and tempering treatment or austempering treatment, iron carbide can be efficiently dispersed in the base. As a result, the mechanical properties of the spheroidal graphite cast iron after the heat treatment can be stabilized, and the durability of the rigid gear 2 can be further enhanced.

In addition, particularly, when the spheroidal graphite cast iron in which the pearlite structure is included in the base is subjected to quenching and tempering treatment, conversion from the pearlite structure to a sorbite structure can be easily caused. That is, conversion from the cementite structure in a layered form to a granular form can be easily caused. As a result, the rigid gear 2, in which a homogeneous sorbite structure is included in the base, and which has particularly favorable toughness and elongation can be realized.

The pearlite structure may exist alone by itself or may exist as a mixed structure with a ferrite structure or another structure.

### [2] Heat Treatment Step S2

Subsequently, the member for an internal gear is subjected to quenching and tempering treatment or austempering treatment. By doing this, the rigid gear 2 (internal gear) is obtained.

### Quenching and Tempering Treatment

In the quenching and tempering treatment, the spheroidal graphite cast iron is sequentially subjected to quenching treatment and tempering treatment.

Among these, as the quenching treatment, for example, a treatment in which a temperature equal to or higher than an austenitizing temperature is sufficiently maintained, followed by rapid cooling in water or an oil thereby causing martensitic transformation is exemplified.

The heating temperature in the quenching treatment (quenching temperature) slightly varies depending on the alloy composition of the spheroidal graphite cast iron, but is preferably 800° C. or higher and 900° C. or lower, more preferably 850° C. or higher and 900° C. or lower.

The holding time of the quenching temperature is appropriately set according to the quenching temperature, the heat capacity of a material to be heated, or the like, but is, for example, preferably 10 minutes or more and 5 hours or less, more preferably 30 minutes or more and 3 hours or less.

The temperature increasing rate in the quenching treatment is appropriately set according to the quenching temperature, the heat capacity of a material to be heated, or the like, but is, for example, preferably 30° C./hour or more and 200° C./hour or less, more preferably 50° C./hour or more and 150° C./hour or less.

When the conditions deviate from the heating conditions as described above, the sorbite structure as described above or a structure equivalent thereto may not be sufficiently formed.

On the other hand, as the tempering treatment, for example, a treatment in which a martensite structure formed by the quenching treatment is preferably heated to a temperature capable of converting it to a sorbite structure, followed by gradual cooling is exemplified.

The heating temperature in the tempering treatment (tempering temperature) slightly varies depending on the alloy composition of the spheroidal graphite cast iron, but is preferably 200° C. or higher and 700° C. or lower, more preferably 250° C. or higher and 650° C. or lower.

The holding time of the tempering temperature is appropriately set according to the tempering temperature, the heat capacity of a material to be heated, or the like, but is, for example, preferably 10 minutes or more and 3 hours or less, more preferably 30 minutes or more and 2 hours or less.

The temperature decreasing rate in the tempering treatment is appropriately set according to the tempering temperature, the heat capacity of a material to be heated, or the like, but is, for example, preferably 10° C./hour or more and 100° C./hour or less, more preferably 20° C./hour or more and 80° C./hour or less.

When the conditions deviate from the heating conditions as described above, the sorbite structure as described above or a structure equivalent thereto may not be sufficiently formed.

### Austempering Treatment

As the austempering treatment, for example, a treatment in which spheroidal graphite cast iron is sufficiently maintained at a temperature equal to or higher than an austenitizing temperature, followed by rapid cooling and maintaining the spheroidal graphite cast iron in a molten salt bath (isothermal transformation treatment) is exemplified.

The heating temperature in the austempering treatment slightly varies depending on the alloy composition of the spheroidal graphite cast iron, but is preferably 800° C. or higher and 900° C. or lower, more preferably 850° C. or higher and 900° C. or lower.

The holding time of the heating temperature is appropriately set according to the heating temperature, the heat capacity of a material to be heated, or the like, but is, for example, preferably 10 minutes or more and 3 hours or less, more preferably 30 minutes or more and 1 hour or less.

The temperature increasing rate in the austempering treatment is appropriately set according to the heating temperature, the heat capacity of a material to be heated, or the like, but is, for example, preferably 30° C./hour or more and 200° C./hour or less, more preferably 50° C./hour or more and 150° C./hour or less.

When the conditions deviate from the heating conditions as described above, the bainite structure as described above or a structure equivalent thereto may not be sufficiently formed.

On the other hand, in the rapid cooling and maintaining in the molten salt bath, the temperature of the molten salt bath is set to, for example, preferably 200° C. or higher and 450° C. or lower, more preferably 230° C. or higher and 400° C. or lower.

The holding time in the molten salt bath is not particularly limited, but is, for example, preferably 10 minutes or more and 2 hours or less, more preferably 30 minutes or more and 1 hour or less.

Examples of the molten salt to be used in the molten salt bath include nitrate-based molten salts and chloride-based molten salts.

When the conditions deviate from the heating conditions as described above, the bainite structure as described above or a structure equivalent thereto may not be sufficiently formed.

### [3] Assembling Step S3

The method for producing a gear device according to this embodiment may further include a step of assembling the rigid gear 2 produced or another component. Further, according to need, the lubricant G or the like is applied. According to this, the gear device 10 is obtained.

As described above, the method for producing a gear device according to this embodiment is a method for producing a gear device such as the above-mentioned gear device 10 and includes a member preparation step of preparing a member for an internal gear containing spheroidal graphite cast iron as a main material, and a heat treatment step of subjecting the member for an internal gear to quenching and tempering treatment or austempering treatment, thereby obtaining the rigid gear 2 that is an internal gear.

According to such a production method, excellent toughness and elongation can be imparted to the rigid gear 2, and the rigid gear 2 having high durability can be efficiently produced. As a result, the gear device 10 having a long life can be efficiently produced.

Hereinabove, the robot, the gear device, and the method for producing a gear device according to the present disclosure are described based on the embodiments shown in the drawings, however, the present disclosure is not limited thereto, and the configuration of each portion can be replaced with an arbitrary configuration having a similar function, and also another arbitrary configuration may be added to the present disclosure.

Further, in the above-mentioned embodiments, the gear device, in which the base stand included in the robot is “the first member” and the first arm is “the second member”, and which transmits a driving force from the first member to the second member is described, however, the present disclosure is not limited thereto and can also be applied to a gear device, in which an n-th (n is an integer of 1 or more) arm is “the first member” and an (n+1)-th arm is “the second member”, and which transmits a driving force from one of the n-th arm and the (n+1)-th arm to the other. In addition, the present disclosure can also be applied to a gear device transmitting a driving force from the second member to the first member.

Further, in the above-mentioned embodiments, a horizontal articulated robot is described, however, the robot according to the present disclosure is not limited thereto, and for example, the number of joints of the robot is arbitrary, and it can also be applied to a vertical articulated robot.

Further, in the above-mentioned embodiments, a case where the gear device is incorporated in the robot is described as an example, however, the gear device according to the present disclosure can also be used by being incorporated in various types of apparatuses having a configuration in which a driving force is transmitted from one of the mutually pivoting first member and second member to the other.

### EXAMPLES

Hereinafter, specific examples of the present disclosure will be described.

### 1. Production of Gear Device (Speed Reduction Gear)

### Example 1

A gear device having a configuration as shown in FIG. 2 was produced.

Here, the produced gear device was configured such that the outer diameter of the internal gear was 70 mm, the inner diameter of the internal gear and the outer diameter of the external gear (meshing reference circle diameter) were 53 mm, and the speed reduction ratio was 80. As the constituent material of the internal gear, spheroidal graphite cast iron having been subjected to quenching and tempering treatment was used, and as the constituent material of the external gear, nickel chromium molybdenum steel (SNCM439) was used.

The Vickers hardness of each of the external gear and the internal gear, the residual stress of the external gear, the surface roughness Ra of each of the external gear and the internal gear, the average crystal grain diameter of each of the constituent material of the external gear and the constituent material of the internal gear, and the type and the addition amount of the additive element contained in the constituent material of the external gear are shown in Table 1.

As the spheroidal graphite cast iron, one in which a pearlite structure is included in the base before being subjected to a heat treatment was used.

Further, in the gear device, a lubricant was used. as this lubricant, a grease containing a base oil (mineral oil) at 80 mass %, a lithium (Li) complex soap as a thickener at 15 mass %, an organic molybdenum compound (organic Mo) as an extreme pressure agent at 4 mass %, and 2,6-di-tert-butyl-4-cresol at 1 mass %, and having a consistency of 325, an oil separation degree of 4 mass %, and a dropping point of 270° C. was used.

The treatment conditions for the quenching and tempering treatment are as follows.
Quenching temperature: 850° C.
Holding time of quenching temperature: 1 hour
Temperature increasing rate in quenching treatment: 100° C./hour
Cooling method: oil cooling
Tempering temperature: 550° C.
Holding time of tempering temperature: 1 hour
Temperature decreasing rate in tempering treatment: gradual cooling at 30° C./hour up to 300° C., and rapid cooling by air cooling up to room temperature

### Examples 2 to 25, Reference Examples 1 and 2, and Comparative Examples 1 to 3

Gear devices were produced in the same manner as in Example 1 described above except that the configurations of the external gear and the internal gear were changed as shown in Table 1.

TABLE 1

| | Configuration of gear device | | | | | | |
|---|---|---|---|---|---|---|---|
| | Flexible gear (external gear) | | | | | | |
| | | | Surface | Average | | Additive element | |
| | Vickers | Residual | roughness | crystal grain | Constituent | | Addition |
| | hardness | stress | Ra | diameter | material | Type | amount |
| | — | MPa | μm | μm | — | — | mass % |
| Example 1 | 400 | −750 | 0.4 | 15 | SNCM439 | — | — |
| Example 2 | 400 | −750 | 0.4 | 15 | SNCM439 | — | — |
| Example 3 | 450 | −750 | 0.4 | 15 | SNCM439 | — | — |
| Example 4 | 450 | −750 | 0.4 | 15 | SNCM439 | — | — |
| Example 5 | 450 | −750 | 0.4 | 15 | SNCM439 | — | — |
| Example 6 | 520 | −750 | 0.4 | 15 | SNCM439 | — | — |
| Example 7 | 480 | −450 | 0.4 | 15 | SNCM439 | — | — |
| Example 8 | 480 | −550 | 0.4 | 15 | SNCM439 | — | — |
| Example 9 | 480 | −950 | 0.4 | 15 | SNCM439 | — | — |
| Example 10 | 480 | −750 | 0.2 | 15 | SNCM439 | — | — |
| Example 11 | 480 | −750 | 0.2 | 15 | SNCM439 | — | — |
| Example 12 | 480 | −750 | 0.4 | 15 | SNCM439 | — | — |
| Example 13 | 480 | −750 | 0.8 | 15 | SNCM439 | — | — |
| Example 14 | 480 | −750 | 1.6 | 15 | SNCM439 | — | — |
| Example 15 | 480 | −750 | 0.4 | 0.5 | SNCM439 | — | — |
| Example 16 | 480 | −750 | 0.4 | 10 | SNCM439 | — | — |
| Example 17 | 480 | −750 | 0.4 | 30 | SNCM439 | — | — |
| Example 18 | 480 | −750 | 0.4 | 15 | SNCM439 | Nb | 0.01 |
| Example 19 | 480 | −750 | 0.4 | 15 | SNCM439 | Nb | 0.1 |
| Example 20 | 480 | −750 | 0.4 | 15 | SNCM439 | Nb | 0.5 |
| Example 21 | 480 | −750 | 0.4 | 15 | SNCM439 | Ti | 0.1 |
| Example 22 | 480 | −750 | 0.4 | 15 | SNCM439 | V | 0.1 |
| Example 23 | 480 | −750 | 0.4 | 15 | SNCM439 | Zr | 0.1 |
| Example 24 | 480 | −750 | 0.4 | 15 | SNCM439 | Ta | 0.1 |
| Example 25 | 480 | −750 | 0.4 | 15 | SNCM439 | Hf | 0.1 |
| Reference Example 1 | 400 | −750 | 0.4 | 15 | SNCM439 | — | — |
| Reference Example 2 | 480 | −750 | 0.4 | 15 | SNCM439 | — | — |
| Comparative Example 1 | 450 | −750 | 0.4 | 15 | SNCM439 | — | — |
| Comparative Example 2 | — | — | — | — | Structural steel | — | — |
| Comparative Example 3 | — | — | — | — | SUS | — | — |

| | Configuration of gear device | | | | |
|---|---|---|---|---|---|
| | Rigid gear (internal gear) | | | | |
| | | Surface | Average | | |
| | Vickers | roughness | crystal grain | Constituent | Evaluation result |
| | hardness | Ra | diameter | material | Life |
| | — | μm | μm | — | rotation |
| Example 1 | 400 | 0.2 | 30 | QT-FCD | 3 × 10⁷ |
| Example 2 | 350 | 0.2 | 30 | QT-FCD | 3 × 10⁷ |
| Example 3 | 450 | 0.2 | 30 | QT-FCD | 5 × 10⁷ |
| Example 4 | 400 | 0.2 | 30 | QT-FCD | 5 × 10⁷ |
| Example 5 | 300 | 0.2 | 30 | QT-FCD | 4 × 10⁷ |
| Example 6 | 400 | 0.2 | 30 | QT-FCD | 9 × 10⁷ |
| Example 7 | 400 | 0.2 | 30 | QT-FCD | 1 × 10⁷ |
| Example 8 | 400 | 0.2 | 30 | QT-FCD | 2 × 10⁷ |
| Example 9 | 400 | 0.2 | 30 | QT-FCD | 8 × 10⁷ |
| Example 10 | 400 | 0.1 | 30 | QT-FCD | 4 × 10⁷ |
| Example 11 | 400 | 0.2 | 30 | QT-FCD | 5 × 10⁷ |
| Example 12 | 400 | 0.4 | 30 | QT-FCD | 6 × 10⁷ |
| Example 13 | 400 | 0.4 | 30 | QT-FCD | 4 × 10⁷ |
| Example 14 | 400 | 0.8 | 30 | QT-FCD | 3 × 10⁷ |
| Example 15 | 400 | 0.2 | 5 | QT-FCD | 9 × 10⁷ |
| Example 16 | 400 | 0.2 | 10 | QT-FCD | 7 × 10⁷ |
| Example 17 | 400 | 0.2 | 40 | QT-FCD | 1 × 10⁷ |
| Example 18 | 400 | 0.2 | 30 | QT-FCD | 7 × 10⁷ |
| Example 19 | 400 | 0.2 | 30 | QT-FCD | 1 × 10⁸ |
| Example 20 | 400 | 0.2 | 30 | QT-FCD | 8 × 10⁷ |
| Example 21 | 400 | 0.2 | 30 | QT-FCD | 8 × 10⁷ |
| Example 22 | 400 | 0.2 | 30 | QT-FCD | 9 × 10⁷ |
| Example 23 | 400 | 0.2 | 30 | QT-FCD | 1 × 10⁸ |
| Example 24 | 400 | 0.2 | 30 | QT-FCD | 6 × 10⁷ |
| Example 25 | 400 | 0.2 | 30 | QT-FCD | 7 × 10⁷ |
| Reference Example 1 | 450 | 0.2 | 30 | QT-FCD | 6 × 10⁴ |
| Reference Example 2 | 400 | 0.8 | 30 | QT-FCD | 7 × 10⁴ |
| Comparative Example 1 | 400 | 0.2 | 30 | FCD | 8 × 10³ |
| Comparative Example 2 | — | — | — | Al alloy | 3 × 10³ |
| Comparative Example 3 | — | — | — | Cu alloy | 1 × 10³ |

The constituent materials shown in Table 1 are as follows.
SNCM439: nickel chromium molybdenum steel SNCM439
Structural steel: mechanical structural carbon steel S45C
SUS: stainless steel SUS420J2
QT-FCD: spheroidal graphite cast iron having been subjected to quenching and tempering treatment
FCD: spheroidal graphite cast iron not subjected to heat treatment
Al alloy: aluminum-silicon-based alloy A4032
Cu alloy: aluminum bronze C6241

### Examples 26 to 28 and Reference Examples 3 and 4

Gear devices were produced in the same manner as in Example 1 described above except that the configurations of the external gear and the internal gear were changed as shown in Table 2.

The treatment conditions for the austempering treatment are as follows.
Heating temperature: 850° C.
Holding time of heating temperature: 1 hour
Type of molten salt bath: nitrate-based molten salt
Temperature of molten salt bath: 300° C.
Holding time in molten salt bath: 1 hour

TABLE 2

| | Configuration of gear device | | | | | | |
|---|---|---|---|---|---|---|---|
| | Flexible gear (external gear) | | | | | | |
| | | | Surface | Average | | Additive element | |
| | Vickers | Residual | roughness | crystal grain | Constituent | | Addition |
| | hardness | stress | Ra | diameter | material | Type | amount |
| | — | MPa | μm | μm | — | — | mass % |
| Example 26 | 450 | −750 | 0.4 | 15 | SNCM439 | — | — |
| Example 27 | 520 | −750 | 0.4 | 15 | SNCM439 | — | — |
| Example 28 | 480 | −750 | 0.4 | 15 | SNCM439 | Nb | 0.1 |
| Reference Example 3 | 400 | −750 | 0.4 | 15 | SNCM439 | — | — |
| Reference Example 4 | 480 | −750 | 0.4 | 15 | SNCM439 | — | — |

| | Configuration of gear device | | | | |
|---|---|---|---|---|---|
| | Rigid gear (internal gear) | | | | |
| | | Surface | Average | | |
| | Vickers | roughness | crystal grain | Constituent | Evaluation result |
| | hardness | Ra | diameter | material | Life |
| | — | μm | μm | — | rotation |
| Example 26 | 400 | 0.2 | 30 | ADI-FCD | 5 × 10⁶ |
| Example 27 | 400 | 0.2 | 30 | ADI-FCD | 9 × 10⁶ |
| Example 28 | 400 | 0.2 | 30 | ADI-FCD | 1 × 10⁷ |
| Reference Example 3 | 450 | 0.2 | 30 | ADI-FCD | 4 × 10⁴ |
| Reference Example 4 | 400 | 0.8 | 30 | ADI-FCD | 5 × 10⁴ |

The constituent materials shown in Table 2 are as follows.
SNCM439: nickel chromium molybdenum steel SNCM439
ADI-FCD: spheroidal graphite cast iron having been subjected to austempering treatment

### 2. Evaluation

### 2.1. Evaluation of Life

With respect to each of the gear devices obtained in the above 1, continuous operation was performed at an input shaft rotational frequency (input shaft rotational speed) of 3000 rpm with an average load torque of 70 Nm, and the total number of rotations of the input shaft until the gear device was broken was measured. Further, the results are also shown in Tables 1 and 2 as the life.

As apparent from Tables 1 and 2, it is found that the respective Examples showed a remarkably longer life than the respective Reference Examples and Comparative Examples.

### 2.2. Evaluation of Crystal Structure

A portion of each rigid gear (internal gear) obtained in the above 1 was cut, and the cut face was subjected to polishing treatment and etching treatment for observing the cut face.

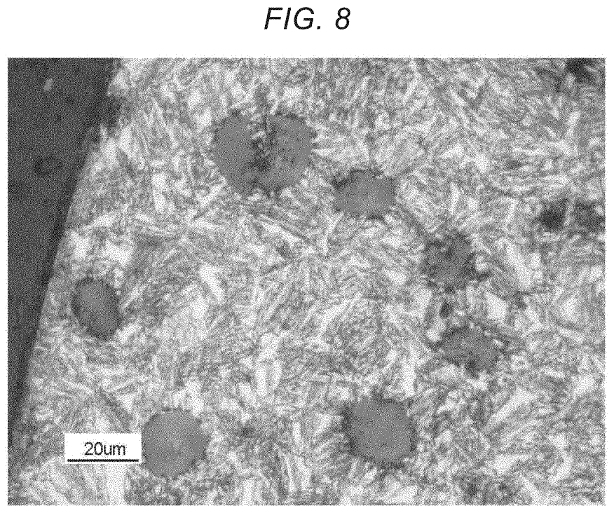

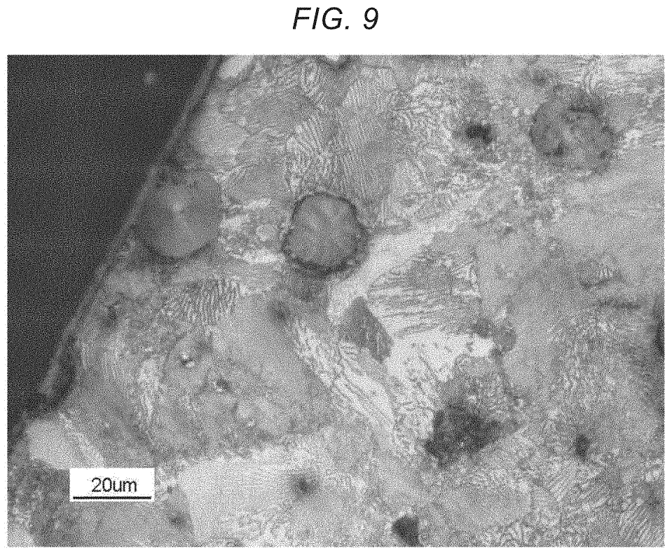

Subsequently, the polished face was observed with a scanning electron microscope. The observation image of the polished face of the rigid gear of Example 4 is shown in FIG. 7 as a representative. Further, the observation image of the polished face of the rigid gear of Example 26 is shown in FIG. 8 as a representative. Still further, the observation image of the polished face of the rigid gear of Comparative Example 1 is shown in FIG. 9 as a representative.

In any of FIGS. 7 to 9, graphite in a granular form and a base (matrix) that is a region other than graphite were observed.

Further, as a result of the observation, on the polished face of the rigid gear of each of Examples 1 to 25, the presence of a sorbite structure specific to spheroidal graphite cast iron having been subjected to quenching and tempering treatment was confirmed in the base portion as shown in FIG. 7.

On the other hand, on the polished face of the rigid gear of each of Examples 26 to 28, the presence of a bainite structure specific to spheroidal graphite cast iron having been subjected to austempering treatment was confirmed in the base portion as shown in FIG. 8.

Further, on the polished face of the rigid gear of Comparative Example 1, the presence of a pearlite structure derived from spheroidal graphite cast iron not subjected to a heat treatment was confirmed in the base portion as shown in FIG. 9.

What is claimed is:

1. A robot, comprising:
a first member;
a second member pivoting with respect to the first member;
a gear device transmitting a driving force for relatively pivoting the second member; and
a driving source outputting the driving force to the gear device, wherein
the gear device includes
an internal gear,
an external gear that has flexibility and that partially meshes with the internal gear, and
a wave generator that is in contact with an inner circumferential face of the external gear and that moves a meshing position of the internal gear and the external gear along a circumferential axis,
one of the internal gear, the external gear, and the wave generator is coupled to the first member, and one of the rest is coupled to the second member, and
the external gear contains nickel chromium molybdenum steel as a main material, and the internal gear contains spheroidal graphite cast iron having been subjected to quenching and tempering treatment or spheroidal graphite cast iron having been subjected to austempering treatment as a main material.

2. The robot according to claim 1, wherein a Vickers hardness of a surface of the internal gear is equal to or less than a Vickers hardness of a surface of the external gear.

3. The robot according to claim 1, wherein a Vickers hardness of a surface of the external gear is within a range of 400 or more and 520 or less.

4. The robot according to claim 1, wherein a Vickers hardness of a surface of the internal gear is within a range of 300 or more and 450 or less.

5. The robot according to claim 1, wherein a residual stress of the external gear is within a range of −950 MPa or more and −450 MPa or less.

6. The robot according to claim 1, wherein a surface roughness Ra of an external tooth of the external gear is within a range of 0.2 μm or more and 1.6 μm or less.

7. The robot according to claim 1, wherein a surface roughness Ra of an internal tooth of the internal gear is within a range of 0.1 μm or more and 0.8 μm or less.

8. The robot according to claim 1, wherein a surface roughness Ra of an external tooth of the external gear is larger than a surface roughness Ra of an internal tooth of the internal gear.

9. The robot according to claim 1, wherein an average crystal grain diameter of the external gear is smaller than an average crystal grain diameter of the internal gear.

10. The robot according to claim 1, wherein the external gear contains a Group 4 element or a Group 5 element in an amount within a range of 0.01 mass % or more and 0.5 mass % or less.

11. The robot according to claim 1, further comprising a lubricant between the internal gear and the external gear, wherein
the lubricant contains a base oil, a thickener, and an organic molybdenum compound, and has an oil separation degree within a range of 4 mass % or more and 13.8 mass % or less.

12. The robot according to claim 1, wherein spheroidal graphite cast iron that is a main material of the internal gear includes a sorbite structure or a bainite structure.

13. A gear device, comprising:
an internal gear;
an external gear that has flexibility and that partially meshes with the internal gear; and
a wave generator that is in contact with an inner circumferential face of the external gear and that moves a meshing position of the internal gear and the external gear along a circumferential axis, wherein
the external gear contains nickel chromium molybdenum steel as a main material, and a constituent material of the internal gear contains spheroidal graphite cast iron having been subjected to quenching and tempering treatment or spheroidal graphite cast iron having been subjected to austempering treatment as a main material.

14. A method for producing a gear device, the gear device including
an internal gear,
an external gear that has flexibility and that partially meshes with the internal gear, and
a wave generator that is in contact with an inner circumferential face of the external gear and that moves a meshing position of the internal gear and the external gear along a circumferential axis,
the method comprising:
preparing a member for the internal gear containing spheroidal graphite cast iron as a main material; and
subjecting the member for the internal gear to quenching and tempering treatment or austempering treatment, thereby obtaining the internal gear.

15. The method for producing a gear device according to claim 14, wherein
the spheroidal graphite cast iron contained in the member for the internal gear contains graphite and a base, and
the base includes a pearlite structure.
